(19) United States
(12) Patent Application Publication
(10) Pub. No.: US 2025/0285260 A1
(43) Pub. Date: Sep. 11, 2025

(54) METHOD FOR DETECTING SEMICONDUCTOR DEFECT USING TEMPERATURE DIFFERENCE CONTRAST

(71) Applicant: SAULTECH TECHNOLOGY CO., LTD., Zhubei City, Hsinchu County (TW)

(72) Inventor: YEN HAO LU, Zhubei City, Hsinchu County (TW)

(21) Appl. No.: 18/613,273

(22) Filed: Mar. 22, 2024

(30) Foreign Application Priority Data
Mar. 7, 2024 (TW) 113108366

(51) Int. Cl. G06T 7/00; H05B 1/02; H05B 3/00

(52) U.S. Cl. CPC G06T 7/001; H05B 1/0233; H05B 3/0047; G06T 2207/10048; G06T 2207/30148

(57) ABSTRACT

A method for detecting semiconductor defect using temperature difference contrast is provided, including the following steps: obtaining an image of the first surface or a second surface of a standard semiconductor; heating part or all of a first surface of a target semiconductor by a heat source; stopping heating part or all of the first surface of the target semiconductor by the heat source; obtaining an image of the first surface or a second surface of the target semiconductor by a thermal imager; and comparing the first surface or the second surface of the standard semiconductor and the first surface or the second surface of the target semiconductor by a detecting unit to determine if the target semiconductor having defects or not. As such, the method can detect the target semiconductor having defects or not with temperature difference contrast under a condition of no damaging the target semiconductor.

### BACKGROUND OF THE INVENTION

### 1. Field of the Invention

The present invention relates generally to a method for detecting semiconductor, and more particularly, to a method for detecting semiconductor defects using temperature difference contrast.

### 2. The Prior Arts

Semiconductor is a substance or material whose electrical conductivity is between that of metallic conductors and insulators. The current method for detecting defects in semiconductors is through sampling a batch of semiconductors, by destroying the sampled target semiconductors by slicing, and then using a scanning electron microscope to check the bonding accuracy to determine whether the target semiconductors are defective.

However, currently there is no detection method available to detect defects in the semiconductor without destroying the semiconductor.

### SUMMARY OF THE INVENTION

A primary objective of the present invention is to provide a method for detecting semiconductor defects using temperature difference contrast, which can detect whether the target semiconductor has defects by using temperature difference contrast without damaging the target semiconductor.

In order to achieve the aforementioned objective, the present invention provides a method for detecting semiconductor defects using temperature difference contrast, which includes the following steps: obtaining an image of a first surface or a second surface of a standard semiconductor; applying a heat source to part or all of a first surface of a target semiconductor for the part or all of the first surface of the target semiconductor to absorb heat from the heat source; the heat source stopping heating part or all of the first surface of the target semiconductor, and part or all of the first surface of the target semiconductor completely diffusing heat in a direction towards part or all of a second surface of the target semiconductor; a thermal imager sensing temperatures of part or all of the first surface of the target semiconductor or temperatures of part or all of the second surface to obtain an image of the first surface or the second surface of the target semiconductor; and an inspection unit receiving the image of the first surface or the second surface of the standard semiconductor and the image of the first surface or the second surface of the target semiconductor, and comparing grayscale of the image of the first surface or the second surface of the standard semiconductor with the image of the first surface or the second surface of the target semiconductor to determine whether the target semiconductor having defects.

In a preferred embodiment, the step of obtaining an image of a first surface or a second surface of a standard semiconductor further includes: the heat source heating part or all of the first surface of the standard semiconductor, and the part or all of first surface of the standard semiconductor absorbing heat from the heat source; the heat source stopping heating part or all of the first surface of the standard semiconductor, and part or all of the first surface of the standard semiconductor diffusing heat in a direction towards part or all of the second surface of the standard semiconductor; and the thermal imager sensing the temperatures of part or all of the first surface of the standard semiconductor or the temperatures of part or all of the second surface to obtain an image of the first surface or the second surface of the standard semiconductor.

In a preferred embodiment, the step of sensing the temperatures of part or all of the first surface of the standard semiconductor or the temperatures of part or all of the second surface of the standard semiconductor by the thermal imager further includes: the thermal imager continuously capturing an image of the temperatures of part or all of the first surface of the standard semiconductor or an image of the temperatures of part or all of the second surface of the standard semiconductor to sense a change of the temperatures of part or all of the first surface of the standard semiconductor or a change of the temperatures of part or all of the second surface of the standard semiconductor.

In a preferred embodiment, the step of determining whether the target semiconductor having defects further includes: compared with the image of the first surface or the second surface of the standard semiconductor, the inspection unit detecting grayscale of the image of at least one point area of the first surface of the target semiconductor to be darker or grayscale of the image of at least one point area of the second surface of the target semiconductor to be lighter, so as to determine that the target semiconductor to be defective and the defect to be at least one conductive wire breakage.

In a preferred embodiment, the step of determining whether the target semiconductor having defects further includes: compared with the image of the first surface or the second surface of the standard semiconductor, the inspection unit detecting grayscale of the image of the first surface of the target semiconductor having at least one less point area or grayscale of the image of the second surface of the target semiconductor having at least one less point area, so as to determine that the target semiconductor to be defective and the defect to be at least one erroneous conductive wire or assembly misalignment.

In a preferred embodiment, the step of determining whether the target semiconductor having defects further includes: compared with the image of the first surface or the second surface of the standard semiconductor, the inspection unit detecting grayscale of the image of the first surface of the target semiconductor having at least one more point area or grayscale of the image of the second surface of the target semiconductor having at least one more point area, so as to determine that the target semiconductor to be defective and the defect to be at least one erroneous conductive wire or assembly misalignment.

In a preferred embodiment, the step of determining whether the target semiconductor is defective further includes: compared with the image of the first surface or the second surface of the standard semiconductor, the inspection unit detecting grayscale of the image of at least one block area of the first surface of the target semiconductor to be darker or grayscale of the image of at least one block area of the second surface of the target semiconductor to be lighter, so as to determine that the target semiconductor to be defective and the defect to be at least one non-conductive wire material to be damaged or erroneous material proportion.

In a preferred embodiment, the step of sensing temperatures of part or all of the first surface of the target semiconductor or temperatures of part or all of the second surface of the target semiconductor by the thermal imager further includes: the thermal imager continuously capturing the image of part or all of the first surface of the target semiconductor or the image of part or all of the second surface of the target semiconductor to sense a temperature change of part or all of the first surface of the target semiconductor or a temperature change of part or all of the second surface of the target semiconductor.

In a preferred embodiment, the heat source applies heat for less than 0.1 second at a temperature greater than 50° C.

In a preferred embodiment, the heat source is a surface light source or a point light source.

The effect of the present invention is that the method of the present invention can use the temperature difference contrast to detect whether the target semiconductor has defects without damaging the target semiconductor.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a flowchart of a first embodiment of the method of the present invention.

FIG. 2 is a schematic view of steps S10 to S30 of the first embodiment of the method of the present invention.

FIG. 3 is a schematic view of steps S40 to S60 of the first embodiment of the method of the present invention.

FIG. 4 is an image of the first surface of a standard die according to the first embodiment of the method of the present invention.

FIG. 5 is an image of the first surface of a target die according to the first embodiment of the method of the present invention.

FIG. 6 is a schematic view of the connection relationship between the thermal imager and the inspection unit of the present invention.

FIG. 7 is an image of the first surface of a standard die according to a second embodiment of the method of the present invention.

FIG. 8 is an image of the first surface of a target die according to the second embodiment of the method of the present invention.

FIG. 9 is an image of the first surface of a standard die according to a third embodiment of the method of the present invention.

FIG. 10 is an image of the first surface of a target die according to the third embodiment of the method of the present invention.

FIG. 11 is a schematic view of steps S10 to S30 of a fourth embodiment of the method of the present invention.

FIG. 12 is a schematic view of steps S40 to S60 of the fourth embodiment of the method of the present invention.

FIG. 13 is a flow chart of a fifth embodiment of the method of the present invention.

FIG. 14 is a schematic view of the first cycle of step S10 to step S30 in the fifth embodiment of the method of the present invention.

FIG. 15 is a schematic view of the first cycle of step S40 to step S60 of the fifth embodiment of the method of the present invention.

FIG. 16 is a schematic view of the second cycle of step S10 to step S30 in the fifth embodiment of the method of the present invention.

FIG. 17 is a schematic view of the second cycle of step S40 to step S60 of the fifth embodiment of the method of the present invention.

FIG. 18 is a schematic view of the third cycle of step S10 to step S30 in the fifth embodiment of the method of the present invention.

FIG. 19 is a schematic view of the third cycle of step S40 to step S60 in the fifth embodiment of the method of the present invention.

FIG. 20 is a schematic view of the fourth cycle of step S10 to step S30 of the fifth embodiment of the method of the present invention.

FIG. 21 is a schematic view of the fourth cycle from step S40 to step S60 of the fifth embodiment of the method of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

The present invention provides a method for detecting semiconductor defects using temperature difference contrast, which includes the following steps:

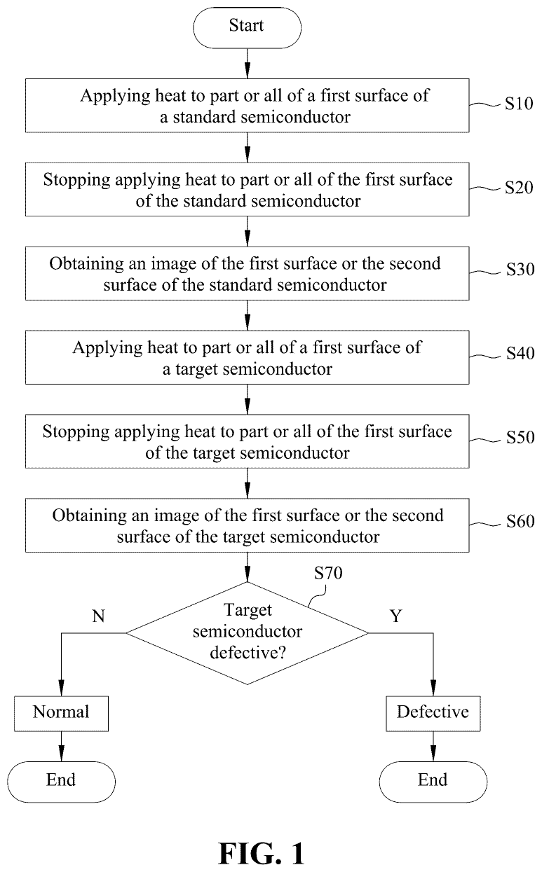

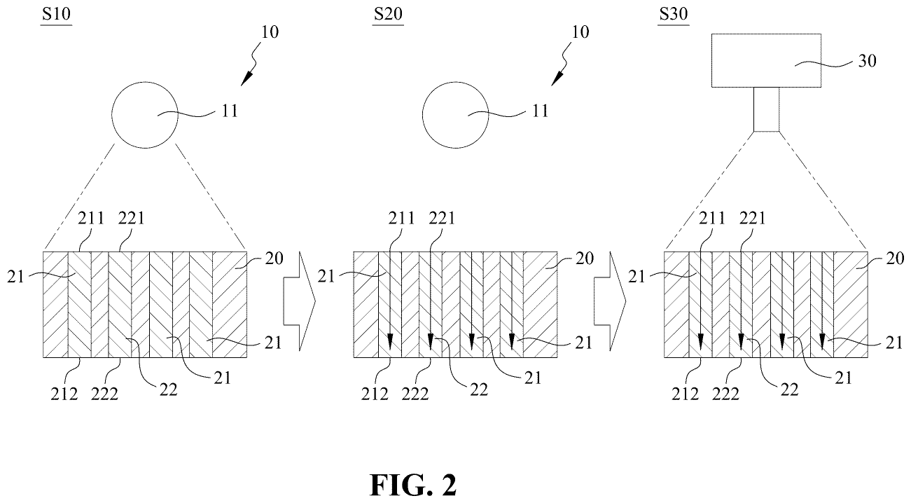

Step S10, as shown in FIGS. 1 and 2, a heat source 10 is a surface light source 11, the surface light source 11 is an infrared heater, and the infrared heater faces first ends 211, 221 of a plurality of conductive wires 21 and 22 of a standard die 20 (all of the first surface of the standard semiconductor) to projects infrared rays, the infrared rays heat the first ends 211, 221 of the conductive wires 21, 22, and the first ends 211, 221 of the conductive wires 21, 22 absorb the heat of the infrared rays. Preferably, the infrared heater is a near-infrared heater or a short-wave far-infrared heater.

Step S20, as shown in FIGS. 1 and 2, the infrared heater stops projecting infrared rays toward the first ends 211, 221 of the conductive wires 21, 22, and the infrared heater stops projecting infrared rays toward the first ends 211, 221 of the conductive wires 21, 22 so that the infrared heater stops heating the first ends 211, 221 of the conductive wires 21, 22, and the heat of the first ends 211, 221 of the conductive wires 21, 22 is diffused in the direction towards second ends 212, 222 of the conductive wires 21, 22 (all of the second surface of the standard semiconductor).

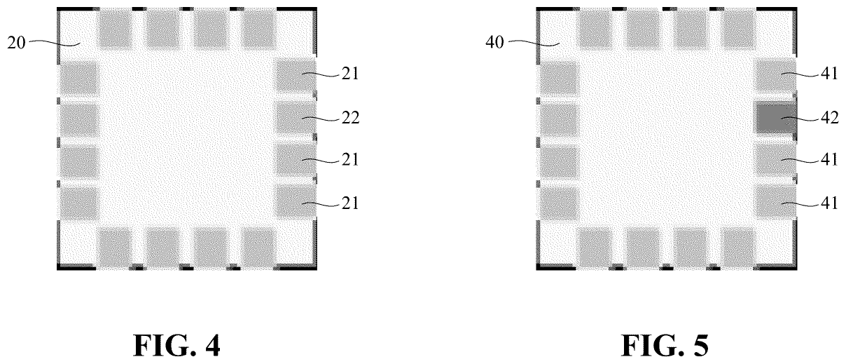

Step S30, as shown in FIGS. 1, 2 and 4, a thermal imager 30 senses the temperatures of the first ends 211, 221 of the conductive wires 21, 22 to obtain an image of the first surface of the standard die 20.

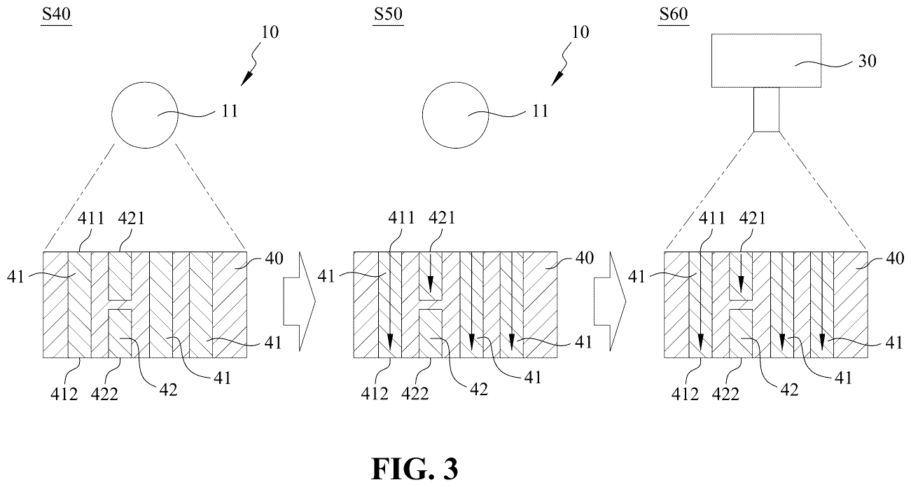

Step S40, as shown in FIGS. 1 and 3, the infrared heater projects infrared rays toward first ends 411, 421 of a plurality of conductive wires 41, 42 of a target die 40 (all of the first surface of the target semiconductor). The first ends 411, 421 of the conductive wires 41, 42 are heated, and the first ends 411, 421 of the conductive wires 41, 42 absorb the heat of infrared rays.

Step S50, as shown in FIGS. 1 and 3, the infrared heater stops projecting infrared rays toward the first ends 411, 421 of the conductors 41, 42 so that the infrared heater stops heating the first ends 411, 421 of the conductors 41, 42, and the heat of the first ends 411, 421 of the conductive wires 41, 42 is diffused in the direction towards the second ends 412, 422 of the conductive wires 41, 42 (all of the second surface of the target semiconductor).

In step S60, as shown in FIGS. 1, 3 and 5, the thermal imager 30 senses the temperatures of the first ends 411, 421 of the conductive wires 41, 42 to obtain an image of the first surface of the target die 40.

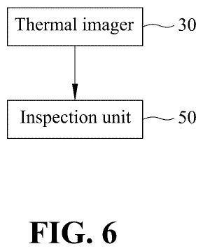

Step S70, as shown in FIGS. 1, 4, 5 and 6, an inspection unit 50 receives the image of the first surface of the standard die 20 and the image of the first surface of the target die 40, and compares grayscales of the image of the first surface of the standard die 20 with grayscales of the image of the first surface of the target die 40; and, compared with the image of the first surface of the standard die 20, the inspection unit 50 detects grayscales of the image of the first end 421 of the conductive wire 42 (a point area on the first surface of the target semiconductor) is darker, which means that the temperature of the first end 421 of the conductive wire 42 is higher than the temperature of the first end 411 of the remaining conductive wire 41 to determine that the target die 40 is defective and the defect is that the conductive wire 42 is broken.

Preferably, step S30 further includes: the thermal imager 30 continuously captures images of the first ends 211, 221 of the conductive wires 21, 22 to sense the temperature change of the first ends 211, 221 of the conductive wires 21, 22.

Preferably, step S60 further includes: the thermal imager 30 continuously captures images of the first ends 411, 421 of the conductive wires 41, 42 to sense the temperatures change of the first ends 411, 421 of the conductive wires 41, 42.

Preferably, the thermal imager 30 is an infrared thermal imager.

Preferably, the heating time of the heat source 10 is less than 0.1 seconds, and the heating temperature is higher than 50° C. In other words, the heat source 10 is instantly energized to a high temperature in a short period of time to achieve the detection operation.

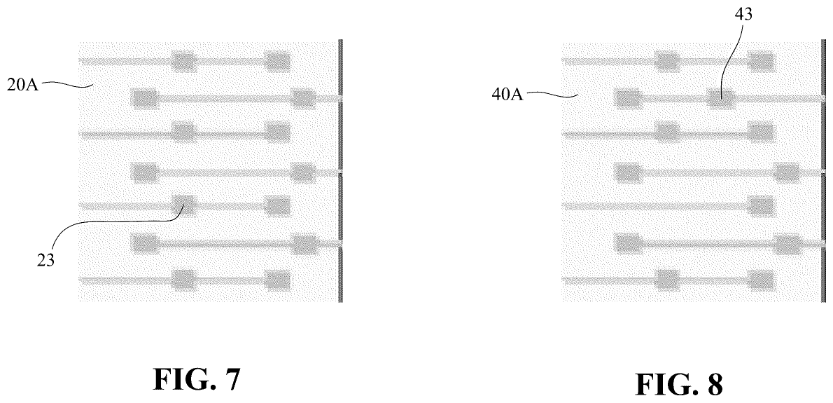

The difference between the second embodiment and the first embodiment is that in step S70, as shown in FIGS. 7 and 8, compared with the image of the first surface of the standard die 20A, the inspection unit 50 detects that the grayscales of the image of first surface of the target die 40A has one less point area 23 and has one more point area 43. As such, the inspection unit 50 determines that the target die 40A is defective and the defect is caused by incorrect wiring or assembly misalignment.

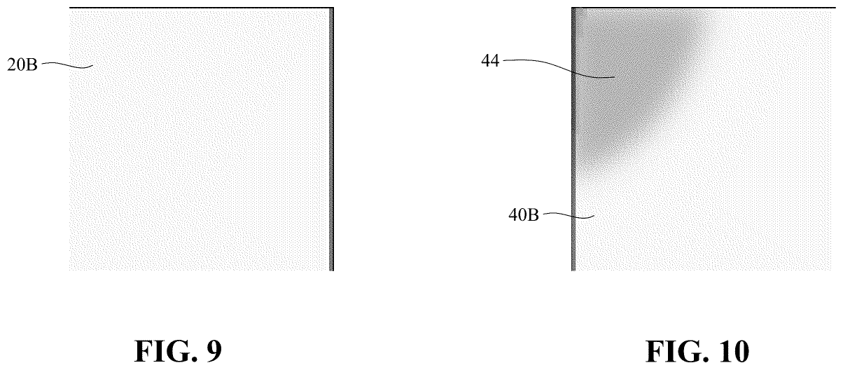

The difference between the third embodiment and the first embodiment is that in step S70, as shown in FIGS. 9 and 10, compared with the image of the first surface of the standard die 20B, the inspection unit 50 detects that the grayscales of the image the first surface of the target die 40B has a block area 44 that is darker to determine that the target die 40B is defective and the defect is that the non-conductive material is damaged or incorrect material ratio.

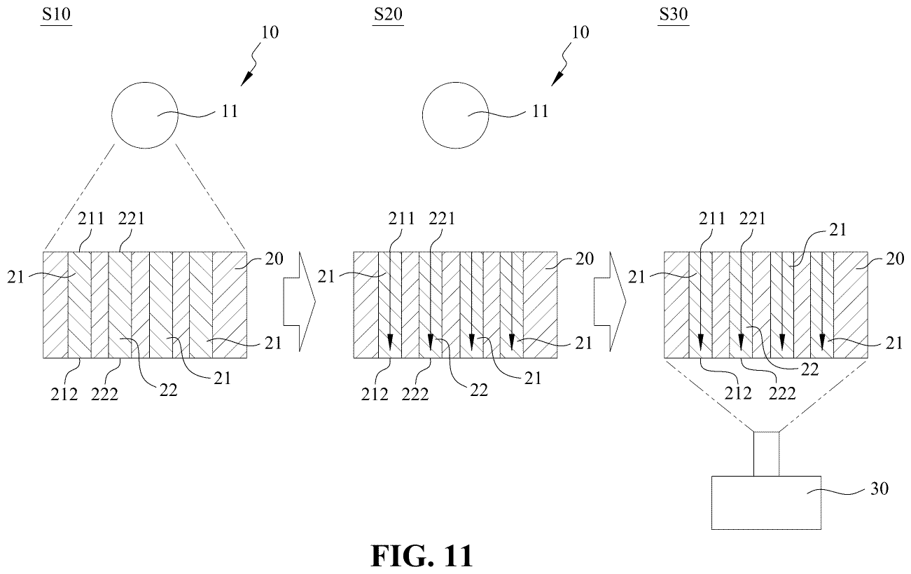

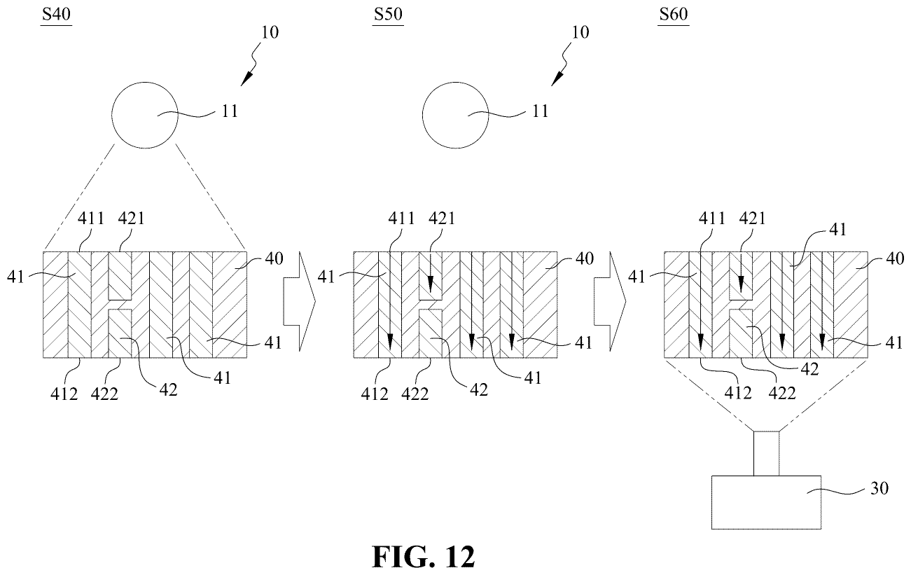

The difference between the fourth embodiment and the first embodiment is that: first, as shown in FIG. 11, the thermal imager 30 senses the temperature of the second ends 212, 222 of the conductive wires 21, 22 to obtain the image of the second surface of the standard die 20; second, as shown in FIG. 12, the thermal imager 30 senses the temperature of the second ends 412, 422 of the conductive wires 41, 42 to obtain an image of the second surface of the target die 40.

Preferably, step S30 further includes: the thermal imager 30 continuously captures images of the second ends 212, 222 of the conductive wires 21, 22 to sense the temperature change of the second ends 212, 222 of the conductive wires 21, 22.

Preferably, step S60 further includes: the thermal imager 30 continuously captures images of the second ends 412, 422 of the conductive wires 41, 42 to sense the temperature change of the second ends 412, 422 of the conductive wires 41, 42.

In some embodiments, the surface light source 11 is a laser heater.

The differences between the fifth embodiment and the first embodiment are as follows:

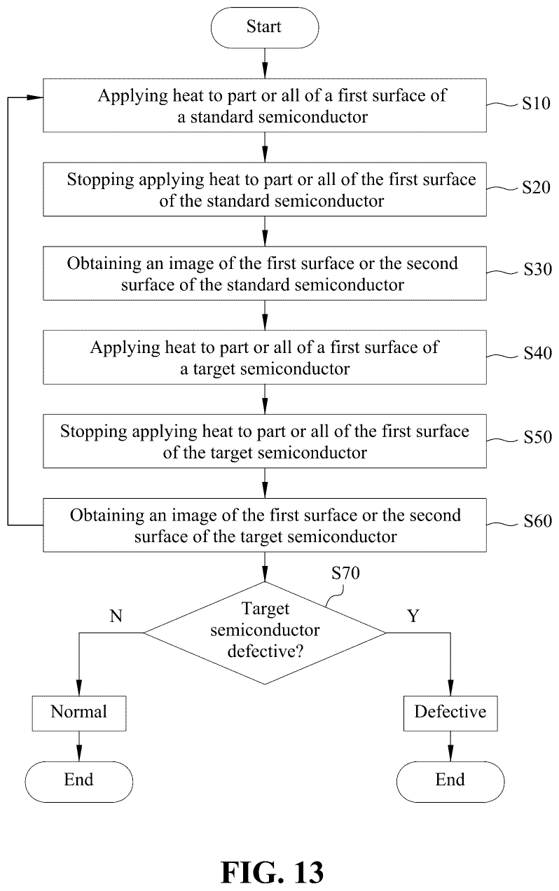

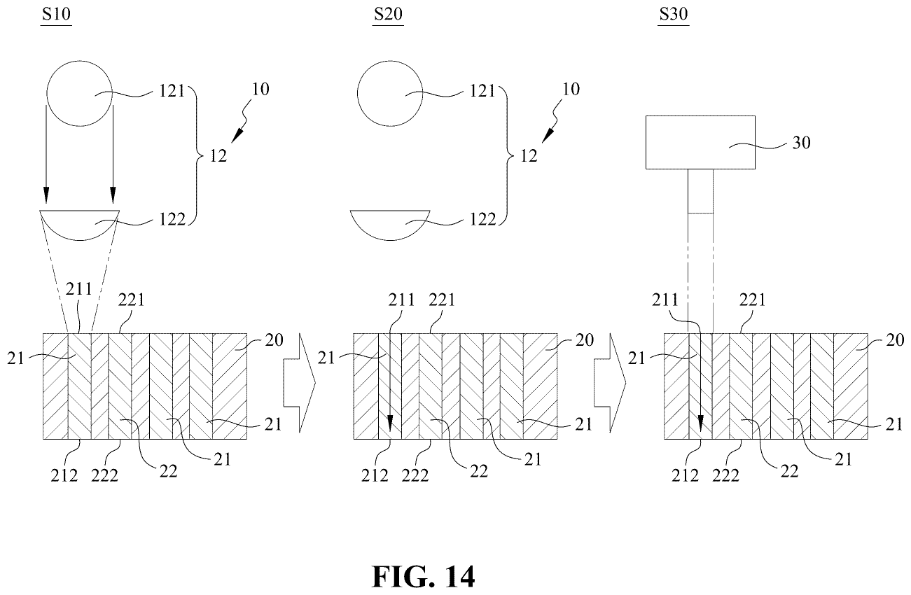

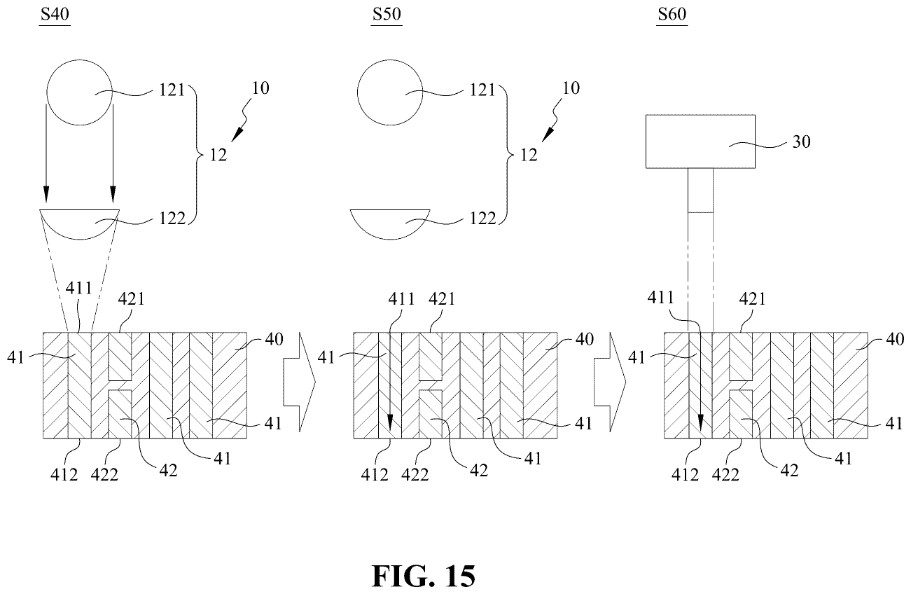

In the first cycle, as shown in FIGS. 13, 14 and 15, step S10, the heat source 10 is a point light source 12. The point light source 12 includes an infrared heater 121 and a convex lens 122. The infrared heater 121 projects infrared rays towards the convex lens 122, and the convex lens 122 focuses the infrared rays and irradiates the focused infrared rays on the first end 211 of one of the conductive wires 21 (part of the first surface of the standard semiconductor), and the infrared rays heat the first end 211 of one of the conductive wires 21, and the first end 211 of one of the conductive wires 21 absorbs the heat of infrared rays; step S20, the infrared heater 121 stops projecting infrared rays toward the convex lens 122, and the convex lens 122 stops focusing the infrared rays to irradiate on the first end 211 of one of the conductive wires 21, i.e., the infrared heater 121 and the convex lens 122 stop heating the first end 211 of one of the conductive wires 21, and the heat of the first end 211 of one of the conductive wires 21 diffuses toward the direction of the second end 212 of one of the conductive wires 21 (part of the second surface of the standard semiconductor); in step S30, the thermal imager 30 senses the temperature of the first end 211 of one of the conductive wires 21; Step S40, the infrared heater 121 projects infrared rays toward the convex lens 122, and the convex lens 122 focuses the infrared rays and irradiates the focused infrared rays on the first end 411 (part of the first surface of the target semiconductor) of one of the conductive wires 41; the infrared rays heat the first end 411 of one of the conductive wires 41, and the first end 411 of one of the conductive wires 41 absorbs the heat of infrared rays; in step S50, the infrared heater 121 stops projecting infrared rays toward the convex lens 122, and the convex lens 122 stops focusing and irradiating on the first end 411 of one of the conductive wires 41, i.e., the infrared heater 121 and the convex lens 122 stop heating the first end 411 of one of the conductive wires 41, and the heat of the first end 41 of one of the conductive wires 41 diffuses towards the direction of the second end 412 (part of the second surface of the target semiconductor) of one of the conductive wires 41; and in step S60, the thermal imager 30 senses the temperatures of the first end 211 of one of the conductive wires 21.

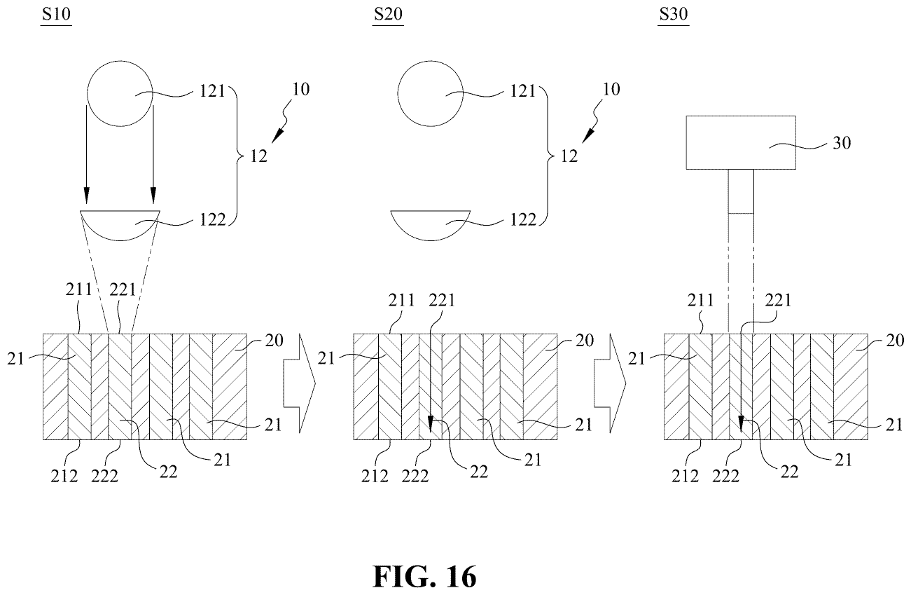

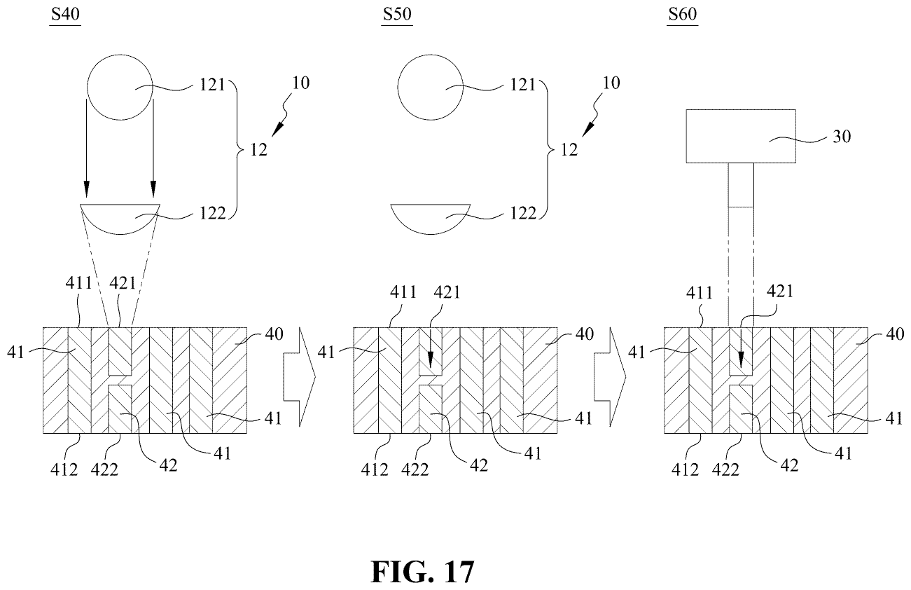

In the second cycle, as shown in FIGS. 13, 16 and 17, the difference from the first cycle is that in step S10, the convex lens 122 focuses the infrared rays and irradiates the focused infrared rays on the first end 221 of the wire 22 (part of the first surface of the standard semiconductor), the infrared rays heat the first end 221 of the conductive wire 22, and the first end 221 of the conductive wire 22 absorbs the heat of the infrared rays; in step S20, the convex lens 122 stops focusing the infrared ray to irradiate on the first end 221 of the conductive wire 22 so that the infrared heater 121 and the convex lens 122 stop heating the first end 221 of the conductive wire 22, and the heat of the first end 221 of the conductive wire 22 diffuses toward the second end 222 of the conductive wire 22 (part of the second surface of the standard semiconductor); in step S30, the thermal imager 30 senses the temperature of the first end 221 of the conductive wire 22; in step S40, the convex lens 122 focuses the infrared rays and irradiates on the first end 421 of the conductive wire 42 (part of the first surface of the target semiconductor), the infrared ray heats the first end 421 of the conductive wire 42, and the first end 421 of the conductive wire 42 absorbs the heat of the infrared ray; step S50, the convex lens 122 stops focusing the infrared ray to irradiate on the first end 421 of the conductive wire 42 so that the infrared heater 121 and the convex lens 122 stops heating the first end 421 of the conductive wire 42, and the heat of the first end 421 of the conductive wire 42 diffuses towards the direction of the second end 422 of the conductive wire 42 (part of the second surface of the target semiconductor); and in step S60, thermal imager 30 senses the temperature of first end 421 of the conductive wire 42.

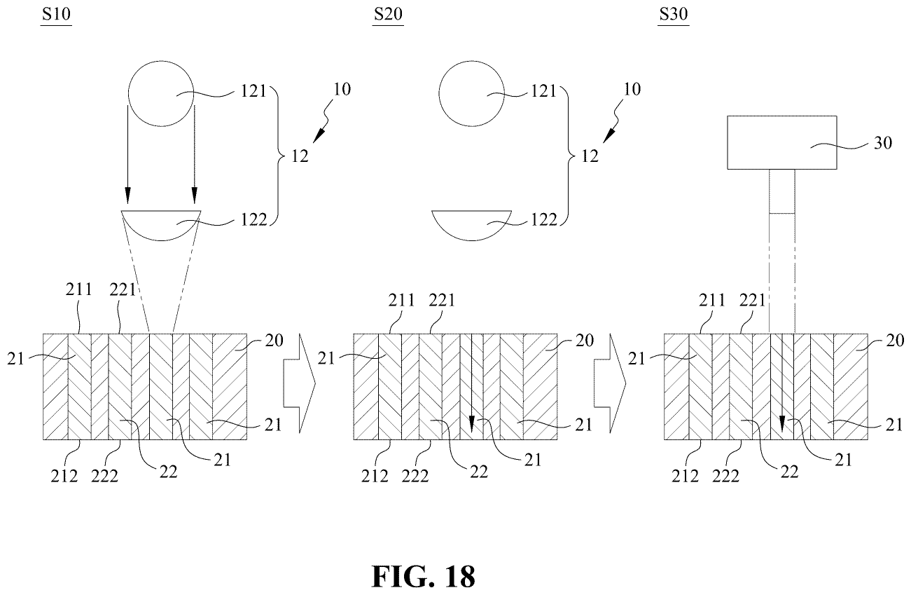

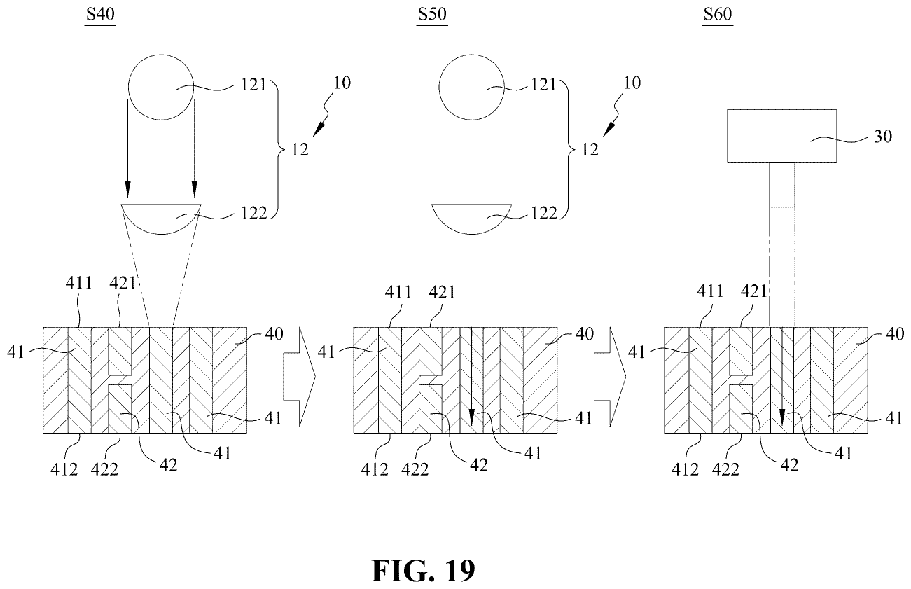

In the third cycle, as shown in FIGS. 13, 18 and 19, the difference from the first cycle is that in step S10, the convex lens 122 focuses the infrared rays and irradiates the focused infrared rays on the first end 211 of the other one of the conductive wires 21 (part of the first surface of a standard semiconductor), infrared rays heat the first end 211 of the other one of the conductive wires 21, and the first end 211 of the other one of the conductive wires 21 absorbs the heat of the infrared ray; in step S20, the convex lens 122 stops focusing infrared rays to irradiate the first end 211 of the other one of the conductive wires 21 so that the infrared heater 121 and the convex lens 122 stop heating the first end 211 of the other one of the conductive wires 21, and the heat of the first end 211 of the other of the conductive wires 21 diffuses towards the direction of the second end 212 of the other one of the conductive wires 21 (part of the second surface of the standard semiconductor); in step S30, thermal imager 30 senses the temperature of the first end 211 of the other one of the conductive wires 21; in step S40, the convex lens 122 focuses the infrared ray and irradiates the focused infrared rays on the first end 411 of the other one of the conductive wires 41 (part of the first surface of the target semiconductor), the infrared ray heats the first end 411 of the other one of the conductive wires 41, and the first end 411 of the other one of the conductive wires 41 absorbs the heat of the infrared ray; in step S50, the convex lens 122 stops focusing the infrared ray to irradiates on the first end 411 of the other one of the conductive wires 41, so that the infrared heater 121 and the convex lens 122 stop heating the first end 411 of the other one of the conductive wires 41, and the heat of the second end 411 of the other one of the conductive wires 41 diffuses towards the direction of the second end 412 of the other one of the conductive wires 41 (part of the second surface of the target semiconductor); and in step S60, the thermal imager 30 senses the temperature of the first end 411 of other one of the conductive wires 41.

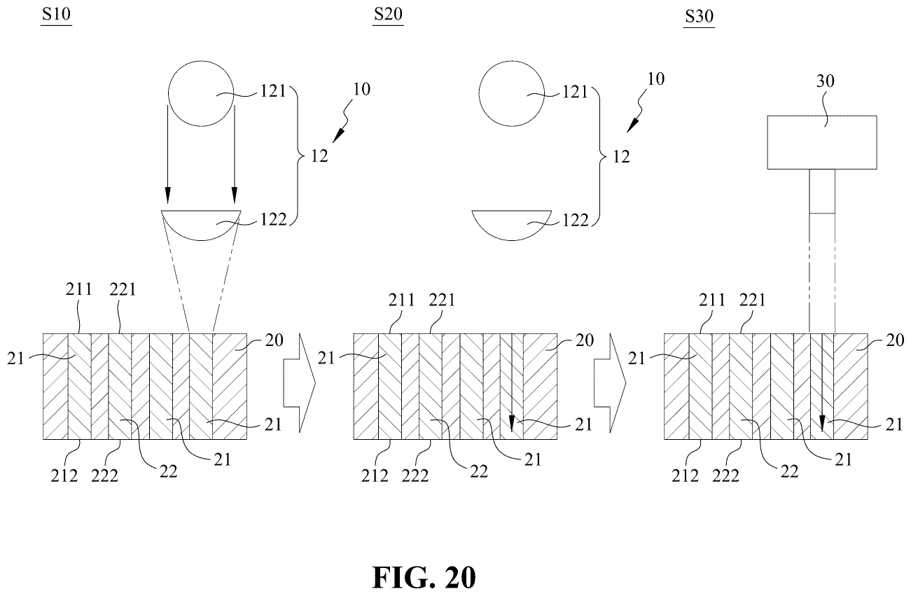

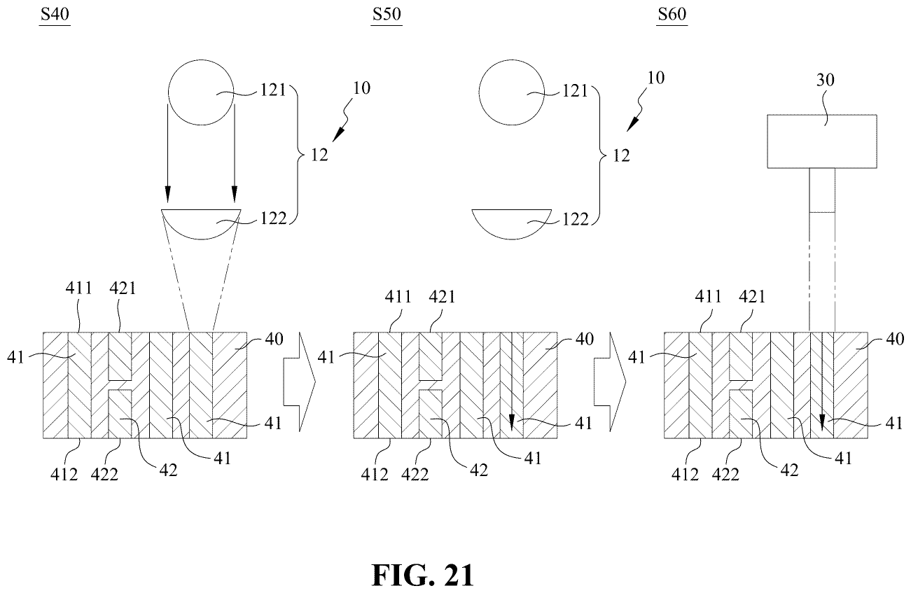

In the fourth cycle, as shown in FIGS. 13, 20 and 21, in step S10, the convex lens 122 focuses the infrared rays and irradiates the first end 211 of yet another one of the conductive wires 21 (part of the first surface of the standard semiconductor), the infrared ray heats the first end 211 of yet another one of the conductive wires 21, and the first end 211 of the yet another one of the conductive wires 21 absorbs the heat of the infrared rays; in step S20, the convex lens 122 stops focusing the infrared ray irradiate on the first end 211 of the yet another one of the conductive wires 21, so that the infrared heater 121 and the convex lens 122 stop heating the first end 211 of the yet another one of the conductive wires 21, and the heat from the first end 211 of yet another one of the conductive wires 21 diffuses towards the direction of the second end 212 of yet another one of the conductive wires 21 (part of the second surface of the standard semiconductor); in step S30, the thermal imager 30 senses the temperature of the first end 211 of yet another one of the conductive wires 21; in step S40, the convex lens 122 focuses the infrared rays and irradiates the focused infrared rays on the first end 411 of yet another one of the conductive wires 41 (part of the first surface of the target semiconductor), and the infrared rays heat the first end 411 of yet another one of the conductive wires 41, and the first end 411 of the yet another one of the conductive wires 41 absorbs the heat of the infrared rays; in step S50, the convex lens 122 stops focusing the infrared ray to irradiate on the first end 411 of yet another one of the conductive wires 41 so that the infrared heater 121 and the convex lens 122 stop heating the first end 411 of yet another one of the conductive wires 41, and the heat of the first end 411 of yet another one of the conductive wires 41 diffuses towards the second end 412 of yet another one of the conductive wires 41 (part of the second surface of the target semiconductor); and in step S60, the thermal imager 30 senses the temperature of the first end 411 of yet another one of the conductive wires 41.

After collecting the temperatures of the first ends 211, 221 of the conductive wires 21, 22 and the temperatures of the first ends 411, 421 of the conductive wires 41, 42, the thermal imager 30 obtains an image of the first surface of the standard die 20 and an image of the first surface of the target die 40. Finally, step S70 is executed to determine that the target die 40 is defective and the defect is a breakage of conductive wire 22.

In some embodiments, the point light source 12 is a laser heater.

In summary, the method of the present invention can detect whether the target semiconductor has defects by using the temperature difference contrast without damaging the target semiconductor.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for detecting semiconductor defects using temperature difference contrast, comprising the steps of:
obtaining an image of a first surface or a second surface of a standard semiconductor;
applying a heat source to part or all of a first surface of a target semiconductor for the part or all of the first surface of the target semiconductor to absorb heat from the heat source;
the heat source stopping heating part or all of the first surface of the target semiconductor, and part or all of the first surface of the target semiconductor completely diffusing heat in a direction towards part or all of a second surface of the target semiconductor;
a thermal imager sensing temperatures of part or all of the first surface of the target semiconductor or temperatures of part or all of the second surface to obtain an image of the first surface or the second surface of the target semiconductor; and
an inspection unit receiving the image of the first surface or the second surface of the standard semiconductor and the image of the first surface or the second surface of the target semiconductor, and comparing grayscale of the image of the first surface or the second surface of the standard semiconductor with the image of the first surface or the second surface of the target semiconductor to determine whether the target semiconductor having defects.

2. The method for detecting semiconductor defects using temperature difference contrast according to claim 1, wherein the step of obtaining an image of a first surface or a second surface of a standard semiconductor further includes: the heat source heating part or all of the first surface of the standard semiconductor, and the part or all of first surface of the standard semiconductor absorbing heat from the heat source; the heat source stopping heating part or all of the first surface of the standard semiconductor, and part or all of the first surface of the standard semiconductor diffusing heat in a direction towards part or all of the second surface of the standard semiconductor; and the thermal imager sensing the temperatures of part or all of the first surface of the standard semiconductor or the temperatures of part or all of the second surface to obtain an image of the first surface or the second surface of the standard semiconductor.

3. The method for detecting semiconductor defects using temperature difference contrast according to claim 2, wherein the step of sensing the temperatures of part or all of the first surface of the standard semiconductor or the temperatures of part or all of the second surface of the standard semiconductor by the thermal imager further includes: the thermal imager continuously capturing an image of the temperatures of part or all of the first surface of the standard semiconductor or an image of the temperatures of part or all of the second surface of the standard semiconductor to sense a change of the temperatures of part or all of the first surface of the standard semiconductor or a change of the temperatures of part or all of the second surface of the standard semiconductor.

4. The method for detecting semiconductor defects using temperature difference contrast according to claim 1, wherein the step of determining whether the target semiconductor having defects further includes: compared with the image of the first surface or the second surface of the standard semiconductor, the inspection unit detecting grayscale of the image of at least one point area of the first surface of the target semiconductor to be darker or grayscale of the image of at least one point area of the second surface of the target semiconductor to be lighter, so as to determine that the target semiconductor to be defective and the defect to be at least one conductive wire breakage.

5. The method for detecting semiconductor defects using temperature difference contrast according to claim 1, wherein the step of determining whether the target semiconductor having defects further includes: compared with the image of the first surface or the second surface of the standard semiconductor, the inspection unit detecting grayscale of the image of the first surface of the target semiconductor having at least one less point area or grayscale of the image of the second surface of the target semiconductor having at least one less point area, so as to determine that the target semiconductor to be defective and the defect to be at least one erroneous conductive wire or assembly misalignment.

6. The method for detecting semiconductor defects using temperature difference contrast according to claim 1, wherein the step of determining whether the target semiconductor having defects further includes: compared with the image of the first surface or the second surface of the standard semiconductor, the inspection unit detecting grayscale of the image of the first surface of the target semiconductor having at least one more point area or grayscale of the image of the second surface of the target semiconductor having at least one more point area, so as to determine that the target semiconductor to be defective and the defect to be at least one erroneous conductive wire or assembly misalignment.

7. The method for detecting semiconductor defects using temperature difference contrast according to claim 1, wherein the step of determining whether the target semiconductor is defective further includes: compared with the image of the first surface or the second surface of the standard semiconductor, the inspection unit detecting grayscale of the image of at least one block area of the first surface of the target semiconductor to be darker or grayscale of the image of at least one block area of the second surface of the target semiconductor to be lighter, so as to determine that the target semiconductor to be defective and the defect to be at least one non-conductive wire material to be damaged or erroneous material proportion.

8. The method for detecting semiconductor defects using temperature difference contrast according to claim 1, wherein the step of sensing temperatures of part or all of the first surface of the target semiconductor or temperatures of part or all of the second surface of the target semiconductor by the thermal imager further includes: the thermal imager continuously capturing the image of part or all of the first surface of the target semiconductor or the image of part or all of the second surface of the target semiconductor to sense a temperature change of part or all of the first surface of the target semiconductor or a temperature change of part or all of the second surface of the target semiconductor.

9. The method for detecting semiconductor defects using temperature difference contrast according to claim 1, wherein the heat source applies heat for less than 0.1 second at a temperature greater than 50° C.

10. The method for detecting semiconductor defects using temperature difference contrast according to claim 1, wherein the heat source is a surface light source or a point light source.
